(19) United States
(12) Patent Application Publication
(10) Pub. No.: US 2025/0229761 A1
(43) Pub. Date: Jul. 17, 2025

(54) BRAKE APPARATUS WITH DISTANCE SENSOR FOR USE WITH A TWIN AXLE OF A TRACK-GUIDED VEHICLE, DISTANCE SENSOR, METHOD FOR OPERATING THE BRAKE APPARATUS AND COMPUTER READABLE MEDIUM

(71) Applicant: Siemens Mobility GmbH, München (DE)

(72) Inventor: Holger Leitel, Pullach (DE)

(21) Appl. No.: 19/018,087

(22) Filed: Jan. 13, 2025

(30) Foreign Application Priority Data
Jan. 12, 2024 (EP) 24151621.0

(51) Int. Cl. B60T 17/22; F16D 66/02

(52) U.S. Cl. CPC B60T 17/228; F16D 66/025

(57) ABSTRACT

A brake apparatus for installation in an intermediate space between the wheels of a twin axle of a track-guided vehicle. The brake apparatus has two subunits able to be moved relative to one another, namely a first subunit with brake linings for the wheels of the first axle of the twin axle and a second subunit with brake linings for the wheels of the second axle of the twin axle. In their installed state, the subunits are supported in a displaceable manner in such a way that, through the displacement of the subunits, contact is made between the brake linings and the wheels. At least one distance sensor is arranged in one of the subunits of the brake apparatus. The distance sensor is configured to measure a distance between the first subunit and the second subunit.

### CROSS-REFERENCE TO RELATED APPLICATION

This application claims the priority, under 35 U.S.C. § 119, of European Patent Application EP 24151621.0, filed Jan. 12, 2024; the prior application is herewith incorporated by reference in its entirety.

### FIELD AND BACKGROUND OF THE INVENTION

The invention contains the following subject matter: a brake apparatus for installation in the intermediate space between the wheels of a twin axle of a track-guided vehicle. The invention further contains the following subject matter: a track-guided vehicle with a twin axle and a brake apparatus built into an intermediate space of the twin axle. The invention further includes the following subject matter: a distance sensor with a measurement apparatus. The invention further includes the following subject matter: a method for operation of a brake apparatus. The invention further contains the following subject matter: a computer program, comprising program commands. The invention further comprises the following subject matter: a computer-readable memory medium for data.

Checking which brake state is present in track-guided vehicles, whether the hand brake is released or applied, whether all brake blocks of a bogie are present and have a sufficient lining thickness, is currently usually ensured by a manual visual check by the wagon technician during the preparation of a train. In accordance with the prior art however, it is also known for the function of a brake apparatus to be able to be checked by means of a distance sensor, which detects a displacement of a linkage system for the brake apparatus.

Australian patent AU 199726833 B2 describes that a brake apparatus can be provided for installation in the intermediate space between the wheels of a twin axle of a track-guided vehicle, wherein the brake apparatus consists of two subunits movable in relation to one another. This brake apparatus is actuated by a linkage that is attached in the vehicle. Therefore, a distance sensor can be installed at a fixed location, which measures a distance to a characteristic point of this brake lever and in this way allows feedback about the position of the brake (released, applied).

European patent EP 1593571 B1, corresponding to U.S. patent No. 7,165,659, furthermore discloses a brake device, which is fastened to a suspension unit in the intermediate space that is formed by the twin axle of a bogie for a track-guided vehicle. As soon as the brake apparatus is actuated, this clamps with brake linings between the wheels of the twin axle, in that the brake linings are pressed onto the wheel tires of the wheels. This brake apparatus forms a compact structural unit, which can be pre-installed and supported by means of the suspension unit in the bogie. This will therefore also be referred to for short below as a compact brake.

The problem that emerges from the prior art explained above is that the use of a distance sensor corresponding to the implementation described in Australian patent AU 199726833 B2 in the compact brake is not possible, since the hanging suspension unit of the brake apparatus means that no defined distance between the latter and other parts of the vehicle is produced.

### SUMMARY OF THE INVENTION

The object of the invention lies in rectifying the prior art problems described. In particular an object is to further improve a brake apparatus for a track-guided vehicle or a track-guided vehicle with a brake apparatus or a method for driving such a brake apparatus or a computer program for carrying out this method as well as a provision apparatus for such a computer program to the extent that, even with a compact design of the brake apparatus, a sensor system can be employed for measuring a characteristic distance.

With the foregoing and other objects in view there is provided, in accordance with the invention, a brake apparatus for installation in an intermediate space between wheels of a twin axle of a track-guided vehicle. The brake apparatus contains two subunits able to be moved relative to one another, and includes a first subunit with brake linings for the wheels of a first axle of the twin axle and a second subunit with brake linings for the wheels of a second axle of the twin axle. The subunits, in an installed state, is supported in a displaceable manner in such a way that through a displacement of the subunits contact is made between the brake linings and the wheels. At least one distance sensor is disposed in one of the subunits of the brake apparatus. The at least one distance sensor is configured to measure a distance between the first subunit and the second subunit.

In accordance with a first aspect of the invention a brake apparatus for installation in the intermediate space between the wheels of a twin axle of a track-guided vehicle is described. Wherein:
a) the brake apparatus consists of two subunits able to be moved relative to one another, namely a first subunit with brake linings for the wheels of the first axle of the twin axle and a second subunit with brake linings for the wheels of the second axle of the twin axle, and
b) the subunits are arranged in the intermediate space and are supported movably in said space in such a way that, through the displacement of the subunits, contact is made between the brake linings and the wheels.

The structure of the brake apparatus, consisting of a first subunit and a second subunit, represents the characteristic feature of compact brakes. The subunits each carry a part of the brake linings employed, so that the main mechanical function, the braking of the wheels of a twin axle, in particular in a bogie, can be carried out entirely by these two subunits. Further functional units of the brake apparatus that are not associated with the mechanical braking process, for example sensor system or energy supply, can also be accommodated outside the brake apparatus. The mechanical actuator, which brings about a relative movement between the subunits and thus contributes to contact between the brake linings and the wheels (apply brake) and ending the braking process (release brake), is part of the brake apparatus and is thus connected mechanically to both the first subunit and also to the second subunit.

The mechanically displaceable support of the subunits makes it possible for the subunits, through the action of the actuator, to be able to move relative to one another, preferably in the horizontal direction or at least essentially in the horizontal direction (more about this below). This relative movement of the two subunits leads to the brake apparatus supported by the brake units of the twin axle on the wheels to be braked moving towards the brake linings and being able to brake the wheels. The fact that the brake apparatus is arranged between the wheels means that the normal forces during braking, which have to be applied to the opposing brake linings so that a braking force arises, increase evenly. This contributes to the compact design of the brake apparatus.

An apparatus is computer assisted or computer implemented when this has at least one computer or processor, or a method is when at least one computer or processor carries out at least one method step of the method.

A computing environment is an IT infrastructure consisting of functional components such as processors, memory units, programs and consisting of data to be processed with the programs, which are used to execute at least one application that has a task to fulfill. Further functional components can consist of sensors and actuators, which enable an interaction between the computing environment and the outside world. The IT infrastructure can also be organized as a network of the said functional components.

Computers are electronic devices with data processing properties consisting of a number of functional components. Computers can for example be clients, servers, handheld computers, communication devices and other electronic devices for data processing, which can have processors and memory units and can also be connected together via interfaces into a network.

Processors can for example be converters, sensors for creation of measurement signals or electronic circuits. A processor can involve a main processor (Central Processing Unit, CPU), a microprocessor, a microcontroller, or a digital signal processor, possibly in combination with a memory unit for storage of program commands and data. A processor can also be understood as a virtualized processor or a soft CPU.

Memory units can be embodied as computer-readable memory in the form of a main memory (Random-Access Memory, RAM) or data memory (hard disk or data medium).

Interfaces can be realized as hardware, for example as a cable or a wireless connection, or as software, for example as an interaction between individual program modules of one or more computer programs.

To avoid any misunderstandings, it should be noted at this point that individual features of a claim are numbered with lower-case Latin letters, without any regard to the claim number when doing so. This means that each letter only occurs once in the complete set of claims, which enables unique addressing of the features concerned of a claim without giving the claim number. This is why the order of the letters is of no significance however.

In accordance with the invention there is provision that:
c) at least one distance sensor is arranged in one of the subunits of the brake apparatus, and
d) the distance sensor is configured to measure a distance between the first subunit and the second subunit.

With the inventive sensor arrangement, it is possible with what are referred to as block-braked vehicles to check, as a result of the axial displacement of the two subunits, whether all linings are present and whether the thickness of the brake linings used is still sufficient and whether the brakes are released or actually applied. This advantageously means that a sensor-assisted monitoring of the brake linings is made possible with just a little measuring effort, since a change in the measured distance can be directly related to a path of the brake linings from a released into an applied state of the brake and vice versa without there having to be any recalculation. This applies at least when measurement of the distance between the first subunit and the second subunit occurs in a horizontal alignment in parallel to the direction of travel of the vehicle.

Moreover, a vehicle can also be modernized by retrofitting the inventive sensor arrangement, since the measuring arrangement with the distance sensor (and possibly further functional components) can be fastened to the surface of the subunits of the brake apparatus without the elements concerned (possibly with relevance as regards approvals) themselves having to be modified in their function or design.

A distance sensor can advantageously be manufactured and installed at low cost, through which the problem can be cost effectively successfully resolved. Typically, the distance sensor consists of a measuring unit, which is attached to one of the subunits (measurement principles by means of a ultrasound or radar waves for example). The distance to a characteristic point of the other subunit can be established in a simple way in this case. There are however sensor principles in which the sensor facility is configured in two parts and a sensor unit is attached in each case at the start and at the end of the distance to be measured (for example, measurement principle with a sender and a transmitter opposite it or a cable between the subunits). In this case the distance sensor is fastened to both subunits.

As mentioned, the subunits are able to be moved relative to one another. Able to be moved relative to one another is to be understood in the sense of the mechanics. i.e. that at least the distance of the subunits from one another is variable. The movement of the movable functional components then leads in the mechanical sense to a movement of the two functional components relative to one another. It is especially advantageous if both subunits are arranged movably in the vehicle (more about this below).

One advantage of the invention lies in the fact that the distance sensor can be accommodated in a space-saving manner in the compact design of brake apparatus. In this case relative movements between the first subunit and the second subunit can be measured, whereby the state of the brake can be established reliably. As will be explained in greater detail below, both typical operating modes (brake applied, brake released) and malfunctions can be established. With the method likewise presented it is possible, with vehicles, which in particular are equipped with a compact brake (CFCB), to check on the car how the actual brake status of the vehicle is, whether the hand brake has been actuated, whether all linings for a double axle, which are normally part of a bogie, are present, and whether the lining thickness of the brake linings still lies above a previously defined limit value.

Depending on the state of the technical requirements, one distance sensor or a number of distance sensors can be built in. If only one distance sensor is built in, then it is advantageous to arrange said senor in the middle of the vehicle, for example in the middle with regard to the wheels of one of the twin axles, i.e. close to an axis of symmetry aligned at right angles and in the direction of travel of the brake apparatus. This form has the advantage that it can be achieved with a minimal outlay in components and therefore is able to be realized at especially low cost. If two distance sensors are built in then it is advantageous to arrange these symmetrically, as regards the direction of travel or the said plane of symmetry, preferably close to the respective wheels of the axles. This form can advantageously be chosen when there is no installation space available in the vehicle for the distance sensor. Moreover, the use of two sensors creates redundancy, so that, on failure of a sensor, measured values can still be created, at least to a restricted degree. Moreover, it is advantageously possible to compare the two distance values with one another in order to establish whether the setting paths of the actuator on the left side and the right side of the brake apparatus deviate from one another.

If the setting paths of the actuator on the right and left deviate from one another, this points to a mechanical fault in the brake apparatus or to the loss of at least one brake lining on just one side of the brake apparatus (which represents the normal case with loss of brake linings). Thus, in the event of the loss of a brake lining information can also be generated as to the side on which the brake lining has been lost. On this side the setting path distance will namely suddenly increase, while on the other side the setting path will remain within the previously established tolerances. This information can be used to generate a message, which is directed to the side on which the brake lining has been lost.

In accordance with a further aspect of the invention, a track-guided vehicle with a twin axle and a brake apparatus installed in an intermediate space in the twin axle is described, wherein:
e) the brake apparatus consists of two subunits able to be moved relative to one another, namely a first subunit with brake linings for the wheels of the first axle of the twin axle and a second subunit with brake linings for the wheels of the second axle of the twin axle, and
f) the subunits are arranged in the intermediate space and are supported movably in the space in such a way that contact is made between the brake linings and the wheels by the displacement of the subunits, and
g) a distance sensor for establishing a brake setting is arranged in the vehicle.

The brake apparatus employed in the vehicle corresponds precisely to the brake facility already described above. The installation of the brake apparatus is thus undertaken, according to the aspects already described above, between the axles of the twin axle/of the bogie, so that a compact installation situation is produced.

In accordance with the invention, the aspects of the invention explained above are determined by:
h) a distance sensor being arranged in at least one of the subunits of the brake apparatus, and
i) the distance sensor being configured to measure a distance between the first subunit and the second subunit.

The advantages associated with the use of this brake facility are also achieved with aforementioned vehicle, which is why just these advantages will be referred to at this point.

In accordance with a further aspect of the invention, a distance sensor with a measurement apparatus and with an attachment apparatus is described. In accordance with the invention, the aspects of the invention explained above are defined by the attachment apparatus being configured to be connected to a subunit of a brake apparatus in accordance with one of the above claims.

The distance sensor can thus be employed in a vehicle or a brake apparatus, as described above. Thus, the advantages already explained above are achieved, to which reference is made at this point.

In accordance with a further aspect of the invention, a computer-assisted method for operation of a brake apparatus, as described above, or a track-guided vehicle with a brake apparatus, as described above, is described.

The method is thus in particular suitable for obtaining inventive advantages during operation of the brake apparatus and also of the vehicle.

In accordance with the invention, the aspects of the invention explained above are determined by a distance between a first subunit and a second subunit of the brake apparatus being measured with a distance sensor.

As already explained, it is advantageously possible to accommodate the distance sensor in the measuring method in a very space-saving manner between the subunits of the brake apparatus and directly to measure the change in distance caused by a relative movement between the first subunit and the second subunit, meaning without any recalculation factors. The compact form of the brake apparatus is advantageously preserved by this.

All methods for measuring distance are basically suitable as measuring methods. Because of the harsh environmental conditions, however, methods that do not need a mechanical connection between the two subunits are of advantage. Furthermore, methods are advantageous which are not influenced or are only influenced a little by a build-up of ice or snow on the sensor. Most advantageous therefore is a distance measurement by radar in the higher frequency range (for example 60 GHz), since such a measurement method is comparatively insensitive to the measurement conditions described.

In accordance with a further aspect of the invention, a computer program is described, containing program commands that, when the program is executed by a computer, cause the program to carry out the method described above.

In accordance with a further aspect of the invention, a computer program product containing program modules with program commands is described, wherein the program modules can run on the same or on different processors. By means of the computer program product, which can comprise one computer program or a number of computer programs, the inventive method and/or its exemplary embodiment are able to be carried out and the advantages described above are obtained by carrying them out.

In accordance with a further aspect of the invention, a computer-readable memory medium for data is described, which stores datasets of the computer program product as claimed in the most recent claim above.

What is more, a provision apparatus for storage and/or provision of the computer program in the form of a computer-readable memory medium is described. The provision apparatus is for example a memory unit, which stores the computer program and provides it for retrieval. As an alternative or in addition the provision apparatus is a network service, a computer system, a server system, in particular a distributed, for example Cloud-based, computer system or virtual computer system, which stores the computer program on a computer-readable memory and preferably provides it in the form of a data stream.

The provision takes place in the form of program datasets describing program modules as a file, in particular as a download file, or as a data stream, in particular as a download data stream, of the computer program. The computer program is transmitted for example using the provision apparatus in a computing environment, so that the inventive method can be made to execute in a computing entity or in a number of in a number of computing entities.

### General Exemplary Embodiments of the Invention

Variants describing developments of the invention are explained below, without restricting the underlying idea of the invention.

In accordance with one variant, the aspects of the invention explained above are defined by the brake apparatus being embodied as a self-supporting structural unit, which has mechanical supports for attachment to a track-guided vehicle.

A self-supporting structural unit can advantageously be pre-installed and supplied directly for final installation of a vehicle. This enables cost advantages to be achieved during installation. Moreover, the function of the brake apparatus and in particular also of the distance sensor can be checked before delivery or installation of the brake unit, whereby an improved quality assurance is made possible.

In accordance with one variant, the aspects of the invention explained above are defined by the mechanical supports consisting of a suspension unit, which permit an essentially horizontal movement of the brake apparatus relative to the track-guided vehicle in the installed state.

A movement in particular in the direction of travel of the track-guided vehicle, i.e. between the wheels of neighboring axles of the twin axle is to be understood as essentially horizontal. The movement is essentially horizontal if, during the movement in the three-dimensional space, the horizontal movement component has the greatest value (more about this below). The horizontal direction of movement is defined by the track-guided vehicle standing on the track and, in relation to this this, a horizontal movement parallel to the track occurring (gradients in the track can be ignored in this case).

The suspension unit thus enables, so to speak, a floating support of the brake apparatus. This can primarily swing back and forth between the neighboring axles of the twin axle. If the brake is activated then the brake apparatus can align itself between the four wheels of the twin axle, in that the brake linings are resting against the braked wheels. Tolerances are advantageously compensated for here, these being influenced by the geometry of the twin axle and by its mounting location (for example a bogie, which bears the axles of the twin axle), the geometry of the brake apparatus and also the degree of wear of the brake linings.

In the support of the brake apparatus by a suspension unit in the way described, the advantages of the inventively used distance sensor become especially clear. Regardless of how the brake apparatus moves between the wheels of the double axle, a relative movement between the subunits of the brake apparatus can still be reliably established, since the distance is measured in the reference system predetermined by the brake apparatus. Expressed in another way, the distance between the characteristic points of the subunits in a coordinate system is determined, which is related to the brake apparatus and moves with the latter.

In accordance with one variant, the aspects of the invention explained above are determined by the measurement apparatus being configured to send out a signal and detecting a reflected portion of this signal, wherein the distance is calculated from the difference in time between the sending and the receipt.

A measurement method constructed according to this functional principle is advantageously suited in particular to harsh environments, as are present on a twin axle in rail traffic. The reason for this is that the measurement principle functions in a non-contact manner. Moreover, it is possible to accommodate the distance sensor (possibly together with a processor for computer-assisted evaluation of the measurement signal created by the distance sensor) as a structural unit on the one subunit and to measure the distance from there to the other subunit. This makes it possible for example to protect the distance sensor against environmental influences by way of a robust housing. Moreover, retrofitting of the distance sensor for the purposes of modernizing brake apparatuses is simplified.

In accordance with one variant, the aspects of the invention explained above are determined by the measured distance being compared with computer assistance with a required distance.

The conclusion from a distance value as to the current brake state of a twin axle of a bogie is produced by a comparison between the required value, a distance value for the subunits, which has been established beforehand for a known brake state corresponding to an expected value, for example within the framework of a calibration (more about this below). If the measured distance corresponds, with a certain tolerance, to the required value, then it can be concluded that the brake state is the same. This applies both for the released and also for the applied state of the brake linings.

In accordance with one variant, the aspects of the invention explained above are determined by:
j) a brake stop value being predetermined as required distance, which is measured for a stop caused by a friction contact between the friction partners of the brake apparatus to be measured being determined, and/or
k) a release reference value being predetermined as required distance, which is measured for a stop in a brake mechanism or a predetermined setting of the brake mechanism in the released state of the brake apparatus.

Thus, there can be provision in accordance with the invention for both the state of the applied brake and also the state of the released brake to be able to be monitored. For both states a required state is to be taken into consideration, namely the first required distance for the applied state in the form of the brake stop value and the second required distance for the released state in the form of the release reference value (in which a stop value, that is a release stop value, can also be involved, if in the released state of the brake a stop limits the release movement of the brake). The first required distance can primarily serve to verify the loss of brake linings, because this leads to a sudden increase in the distance created between the two subunits in state in which the brake is applied. The second required distance can serve to establish whether the brake can be fully released again. When the brake apparatus is jammed for example, this will no longer be able to set the required distance on release of the brake.

In a typical brake system, a change in distance of 5 . . . 20 mm between the two brake states is to be expected. If, in a brake state, the measured distance deviates by more than the expected tolerance from the expected value, it can be concluded from this that the brake is not working correctly. As explained, measured values that are too great in the applied state allow it to be concluded that there is a loss of a brake block or of another part of the brake system. Measured values that are too small in this state indicate either a malfunction of the brake system (brake cylinder) or a jamming of the mechanism.

In the brake apparatus, putting the brake linings onto the other friction partner of the brake, preferably the wheel tires of the wheels, is to be understood as a stop for which monitoring is to apply. The force is transmitted from the actuator (for example brake cylinder) to the brake in this case via the subunits of the brake apparatus.

In accordance with one variant, the aspects of the invention explained above are determined by the brake stop value being stored as a calibration value for the brake stop and/or the release reference value as a calibration value for a reference position in the released state of the brake, for example a release stop.

The method step of a calibration is in particular of advantage when the brake linings have just been renewed and thus no measured values are yet available for the expected (or also new) brake system. The stop values/reference values, which are then determined by an activation or deactivation of the brake as a brake stop value and release reference value from the associated measured values, then form a reference for the new state of the brake linings, which can be stored in a memory facility.

A calibration step can also be performed, however, during the period in which brake linings are in use. For example, the wear on the brake linings can be measured precisely on a rotational basis during maintenance measures and new calibration values subsequently created for the measured state of the brake linings.

Through the wear on the brake linings the measurable distance in the brake stop increases ever more over the course of time. Over the entire life of the brake linings, in a typical brake system there is likely to be an increase in the brake stop value of approx. 100 mm. This is produced by the wear on the two brake linings of a side of twin axle by up to 50 mm in each case. Wear on the wheels (over the life of the wheels of up to 90 mm of the wheel diameter) is small by comparison with wear on the brake linings in relation to the duration of the life of the brake linings and can therefore be ignored. The wear on the brake linings between two consecutive braking operations is so small that it amounts to less than the measurement tolerance to be aimed for the measured distance.

In accordance with one variant, the aspects of the invention explained above are determined by the brake stop value and/or the measured distance being compared, with computer assistance, with a limit value for the required distance and there being an output as to whether the stop value falls below the limit value and/or reaches it and/or exceeds it.

By contrast with the brake stop value and the release reference value, the limit value is a value that is given by the construction for a specific brake apparatus. It thus involves a constant value that does not change during the wear on the brake lining, but which the measured values measured get closer as the wear on the brake linings progresses. The limit value, after it has been established (in the new state of the brake linings for example), can thus be stored permanently after it has been established in a computing environment that is used for the computer-assisted handling of the method. As soon as the limit value is reached with the brake applied and for example there is no loss of a brake lining, this can be evaluated as an indication that replacement of the brake linings is required.

If this limit value is reached, the information (in the form of a maintenance message) can either be sent electronically to the employee responsible for maintenance, or visualized to the wagon technician by means of a display facility fitted to the vehicle (for example the display of a brake monitoring system in or on the vehicle).

In accordance with one variant, the aspects of the invention explained above are determined by a series of measurements of brake stop values and/or a series of a series of measurements of release reference values being created and by the current brake stop value and/or release reference value being compared with at least one earlier brake stop value and/or release reference value of the series of measurements.

Since the wear on the brake linings between two braking operations lies in the micrometer range, under normal circumstances no change in terms of measurement is able to be determined between two braking operations. The creation of a series of measurements makes it possible to trace the development. This for example enables predictions about the course of the wear and about impending maintenance measurements such as changing the brake linings.

In accordance with one variant, the aspects of the invention explained above are determined by the difference between the current brake stop value and an earlier brake stop value of the series of measurements being calculated and there being an output as to whether this difference falls below a maximum permitted difference and/or reaches it and/or exceeds it.

In this case the maximum permitted difference is determined from empirical values for a specific type of brake construction in such a way that this lies above a value applicable for the conventional wear on the brake linings. This means that a brake stop value that falls below this maximum permissible difference was measured due to an extraordinary event. With the proviso that the measuring method is functioning correctly, the exceeding of the maximum permitted difference therefore points to the loss of at least one brake block. This loss is namely compensated for the in the brake apparatus by this being adjusted by setting a larger setting path of the setting element concerned until such time as all brake linings and the (at least partly) one receptacle of the missing brake blocks have reached the brake stop.

Thus if at least one of the blocks (as the brake linings are also called) is lost, the distance to be covered by the lever during braking increases suddenly. This increase in distance is also expressed by a sudden and measurable change in the said setting path. This can be established by a simple comparison with the last stop value calculated of the series of measurements.

Since a lost brake block cannot be replaced while on the move, it is normally sufficient to take the measurement before the start of the journey or after the end of the journey and to store the measured value. The comparison is then always carried out between the current value and the stored value (for this application case the consideration of a series of measurements with two stop values, the current one and the impending one) is sufficient.

In accordance with one variant the aspects of the invention explained above are determined by the measuring of the distance being carried out while the vehicle is at a standstill.

A great advantage lies in the fact that, when the vehicle is stationary during the measurement method, the brakes can be activated and deactivated (briefly) for the purpose of creating the measured values. In this way it is possible to establish both a brake stop value and also a release reference value shortly after one another. This method is also referred to as a brake test and is prescribed in rail traffic shortly before the departure of a train. This can advantageously be carried out automatically with the method, so that there is no need for an employee to step off a train formation (normally a freight train) for the purpose of taking the brake test.

Drawing elements that correspond to one another or are the same are provided with the same reference characters in each case and will only be explained more than once in respect of how differences between the individual figures are produced.

The exemplary embodiments explained below involve preferred forms of embodiment of the invention. In the exemplary embodiments the components of the forms of embodiment described each represent individual variants of the invention, to be considered independently of one another, which each also develop the invention independently of one another and are thus to be seen, individually or in a combination other than the one shown, as an element of the invention. Furthermore, the components described are also able to be combined with the variants of the invention described above.

Other features which are considered as characteristic for the invention are set forth in the appended claims.

Although the invention is illustrated and described herein as embodied in a brake apparatus with distance sensor for use with a twin axle of a track-guided vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an exemplary embodiment of the inventive apparatus (bogie as part of the vehicle with brake apparatus) with its effective relationships between the functional components that are employed;

FIG. 2 is block diagram showing an exemplary embodiment of a computing environment for the apparatus in accordance with FIG. 1 of the individual functional components and of interfaces embodied between these, wherein individual computing entities execute program modules that can each run in one or more of the computers shown by way of example and wherein the interfaces shown can be configured accordingly as software interfaces in a computer or as hardware interfaces between various computers;

FIG. 3 is a diagram showing a change in a distance between subunits and is represented as a function of individual measurements n, which produce a series of measurements;

FIGS. 4 and 5 is a flow diagram showing an exemplary embodiment of the inventive method, wherein the method steps shown can be realized individually or in groups by program modules and wherein the computing entities and interfaces in accordance with FIG. 2 are shown by way of example.

### DETAILED DESCRIPTION OF THE INVENTION

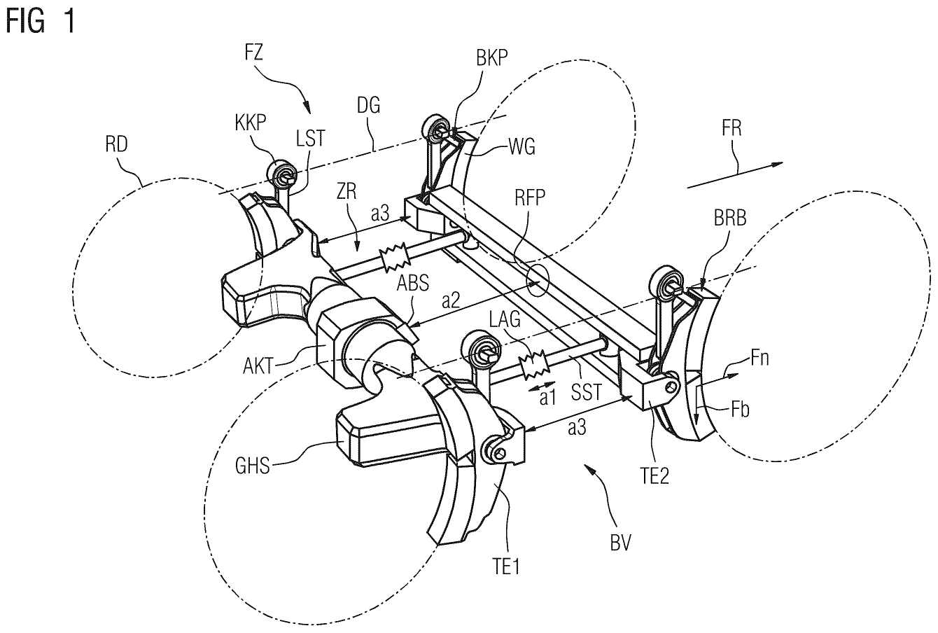

Referring now to the figures of the drawings in detail and first, particularly to FIG. 1 thereof, there is shown a vehicle FZ which is indicated in FIG. 1 by a schematically represented bogie DG, which supports wheels RD in two axes of a twin axle. Also represented schematically is a brake apparatus BV arranged in an intermediate space ZR between the axles, which transmits a movement of an actuator AKT to the brake linings BRB, wherein the brake linings BRB act with a normal force Fn on wheel tires not shown of the wheels RD, wherein a braking force Fb arises.

The brake apparatus BV is shown in three dimensions with a first subunit TE1 and a second subunit TE2. The first subunit TE1 has a housing GHS, which houses a mechanism not shown in any greater detail for transmitting the setting movement of the actuator AKT likewise accommodated in the housing GHS. In a manner likewise not shown, the mechanism transfers a setting movement to push rods SST, which at least primarily carry out a translational movement, in order to increase or to decrease a distance between the two subunits (TE1 . . . TE2) (indicated in FIG. 1 by double arrows representing distances a1 . . . a3 parallel to the push rod alignment).

The brake apparatus BV is suspended in the bogie DG with the aid of four support bars LST. The support bars LST for their part has ball heads KKP auf, which are attached in the bogie DG in a way known per se (not shown). The ball heads KKP permit a movement primarily in the horizontal direction, and indeed in a direction of travel FR or against this direction of travel FR. In this case the suspension units that cannot be seen of the support bars LST in the brake apparatus BV describe arcs about the fixed points defined by the ball heads KKP in the bogie DG. Since the support bars LST are aligned essentially at right angles however, the technically relevant circle segment of this arc essentially leads to a horizontal movement. The ball heads KKP also allow a certain movement in a horizontal direction at right angles to the direction of travel FR. This is restricted constructively however by side plates WG of brake heads BKP that bear the brake linings BRB.

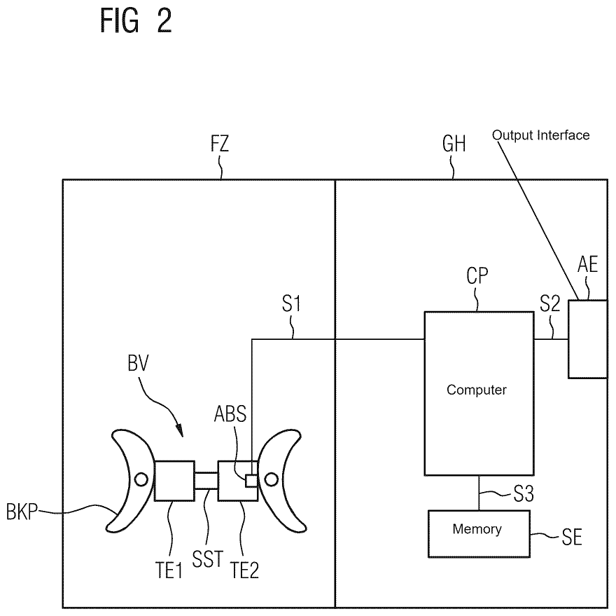

Attached to the first subunit TE1 is a distance sensor ABS. Attached to the opposite subunit, the second subunit TE2, is (optionally) a reflection plate RFP, which reflects radiation, preferably radar radiation, emitted from the distance sensor ABS, so that the reflected radiation can be detected by the distance sensor ABS (the reversed arrangement not shown in any greater detail with the distance sensor on the second subunit and the optional reflection plate on the first subunit is able to be imagined precisely). The at least one distance sensor ABS communicates via an interface not shown in any greater detail (S1, S2 in FIG. 2) with an output facility AE, wherein the output facility AE also contains a computer for evaluating the received measured values (cf. also FIG. 2). As an alternative cabled interfaces can also be used (not shown).

The location of the arrangement of the distance sensor ABS is chosen in FIG. 1 by way of example. Since the two subunits move within a horizontal plane in parallel to the track not shown in the figure linearly away from one another or towards one another, the distance can also be measured in the intermediate space ZR. A first distance a1 is shown, which can be measured by a length comparison LAG of one of the pushrods SST, a second distance a2, which is measured by the distance sensor ABS shown by way of example in interaction with the reflection plate RFP in or close to plane or symmetry not shown, at right angles and aligned in the direction of travel (and serves, without restricting its general applicability, for the further description of the exemplary embodiments) and a third distance a3, which alternatively can be measured in each case externally on the subunits between the wheels of the neighboring axles by two distance sensors not shown.

Shown schematically as a block diagram in FIG. 2 is the interaction between the functional elements involved in the inventive method. The figures shows a block symbolizing the vehicle FZ and a Block GH, which contains both the distance sensor ABS and also an output facility AE and is connected to a computer CP via a second interface S2. In the vehicle FZ the brake apparatus BV from FIG. 1 is shown by way of example, but without the optional reflection plate RFP however.

The distance sensor is connected via a first interface S1 to the computer CP, which evaluates the measurement results. The computer CP is also connected via a third interface S3 to a memory facility SE, wherein calculated required values in the form of a series of measurements, as well as calibration values for commissioning of the brakes and limit values for their wear can be stored there in the memory facility SE. The computer CP is connected to the output facility AE via the output interface S2, wherein the output facility AE is preferably a display that can show information relating to the operation of the brake, or a system with for example a wireless interface that can transmit the information directly to a central point, for example the locomotive (not shown). The output facility AE can be embodied in the simplest case by (at least) one lamp that, without further information, merely shows the need for maintenance (flashing for wear on the brake linings BRB beyond a wear limit, loss of brake blocks/brake linings) the current state of the brakes (lit corresponds to applied/not lit corresponds to released).

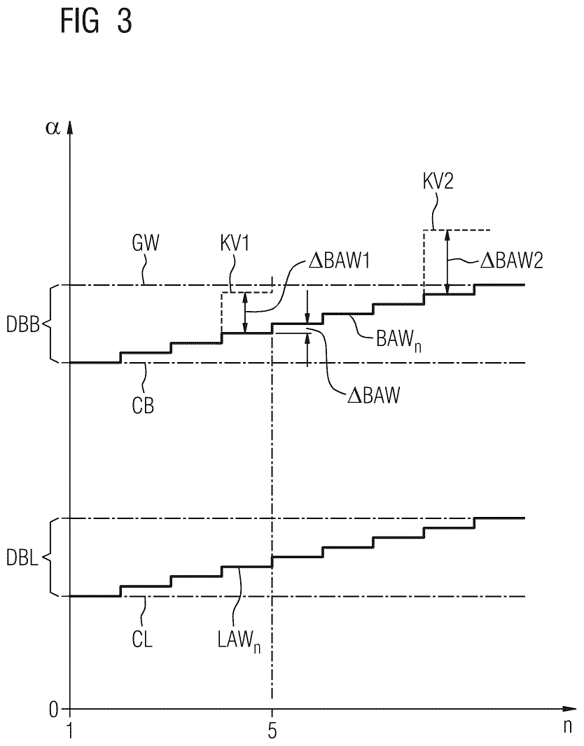

FIG. 3 shows how the required value of a characteristic distance,

namely a brake stop value BAW and a release reference value LAW (measured as described for FIG. 2), changes during the course of individual measurements n that take place through the wear on the brake linings. It becomes clear here that measurements are only carried out at discrete points in time, for example before the vehicle is put into operation in each case, and through this a stepped course is produced. Shown in each case are individual measurements n for the brake stop value BAWn as well as output facility n for the release reference value LAWn. The release reference value LAW and also the brake stop value BAW are each established from the distances between the first subunit TE1 and the second subunit TE2 measured with the distance sensor ABS.

In the first measurement in accordance with FIG. 3 (n=1) the brake linings are in their new state. With this measurement the inventive measuring arrangement is calibrated, wherein a calibration value CL is calculated for the release reference value LAW1 and a calibration value CB is calculated for the brake stop value BAW1. These can be stored in the memory facility SE (cf. FIG. 2).

In the subsequent measurements, the measured second distances a2 increase through wear on the brake linings (and thus also the brake stop values BAWn measured for each brake operation or brake test). The release reference values LAWn can also change, as is shown in FIG. 3, when, depending on brake lining wear, a mechanical adjustment of the reference position provided during release of the brake is carried out (depending on the form of construction of the compact brake). If such an adjustment of the reference position does not take place, the release reference value LAW remains constant.

For the development of the brake stop value BAWn, a limit value GW is depicted in FIG. 3, which specifies that the brake linings have reached their wear limit. The calibration value for the brake stop CB as well as the limit value GW define a drift range for the brake stop DBB. A drift range DBL for the release reference value is thereby produced automatically by the mechanical adjustment of the reference position (when a stop is involved, in particular the release stop).

As already mentioned, the stages in the course of the brake stop value BAW arise through the wear on the brake linings, wherein between individual measurements n, n+1, a wear-related difference lies between two brake stop values ΔBAW. This is normally small and lies in the micrometer range. In order to avoid measurement inaccuracies, there can therefore also be recourse when creating a series of measurements (which is shown by the stepped course in accordance with FIG. 3) to a measurement lying further back, for example to the brake stop value BAWn−10, for a measurement n.

Also shown in FIG. 3 is a jump in the brake stop value BAW by way of example for a loss of a brake block KV1 or for a loss of two brake blocks KV2. It is clear that the difference ΔBAW1 and also the difference ΔBAW2 turn out to be significantly higher than the difference ΔBAW for regular brake block wear, since the possible relative movement between the two subunits TE1, TE2 (measured by the change in the second distance a2) increases suddenly. Through this, the loss of brake blocks is recognized and can be output via the output facility AE.

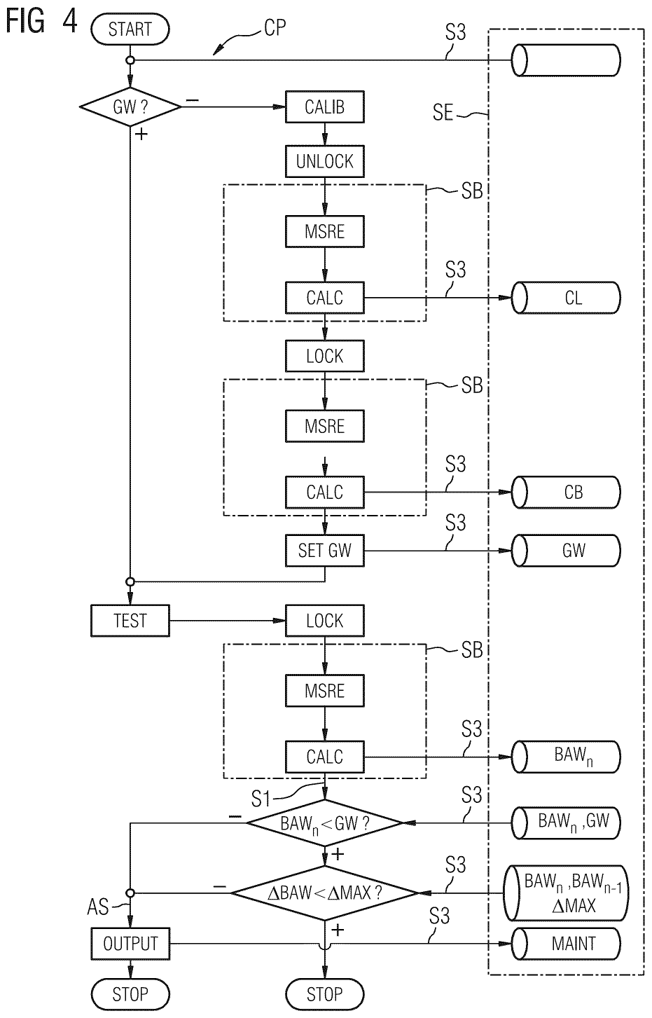

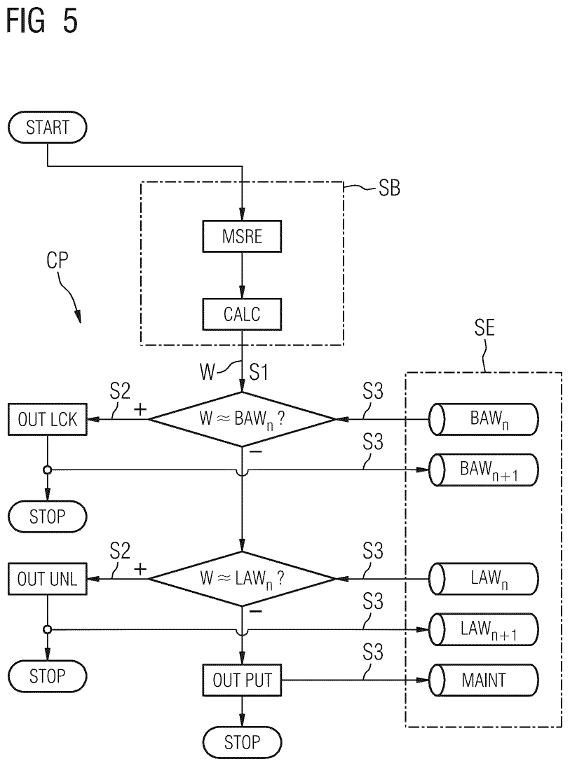

The inventive method is to be explained step-by-step by way of example below, as depicted in the flow diagram in accordance with FIG. 4 or 5. Indicated moreover by boxes in FIG. 4 or 5 by way of example are the functional components or computing entities in accordance with FIGS. 1 and 2 in which the individual steps can be carried out. Where the interfaces in accordance with FIGS. 1 and 2 are used here, these are also identified in FIG. 4 or 5.

The execution sequence of the method for the inventive measurement method can be taken by way of example from FIG. 4. After the method has been started, the available parameters are loaded from the memory facility SE. In an interrogation step, a check is made as whether a limit value GW is already available. If not, the brake linings involved are new, which is why a calibration step CALIB is carried out.

During calibration, the brakes are first released in a deactivation step UNLOCK. Then, in a measurement step MSRE of the distance sensor ABS, a distance values is established. In a subsequent calculation step CALC, the calibration value for the reference position CL is calculated and transferred into the memory facility SE.

The calculation of the calibration value for the reference position CL as well as further release reference values LAW and also brake stop values BAW (inclusive of the calibration value for the brake stop CB) are carried out in the exemplary embodiment in accordance with FIG. 4 by a sensor module SB, which also makes available computing capacity (which takes over the functionality of the computer CP in accordance with FIG. 2) for the calculation step CALC. This is however only an exemplary embodiment. It is also possible for the measurement steps for the second distance a2 to be passed to the computer CP. This represents the configuration that was described in accordance with FIG. 2. For FIG. 4 (and likewise for FIG. 5) it is true to say in this case that the system limit indicated by the dotted and dashed line would be dispensed with for sensor module SB, without any other changes being made to the execution sequence of the method.

In the next step, there is an activation step LOCK for the brake, so that the brake linings rest against the brake stop. The measurement and calculation step MSRE and CALC described here are repeated and deliver the calibration value for the brake stop CB (which in a configuration in accordance with FIG. 2 is transferred by the computer CP to the memory facility SE).

In the subsequent step, starting from the calibration value for the brake stop CB and the knowledge of the circumstances of the brake system, which can be held as formulas in the memory facility SE, in a determination step for the limit value SET GW the limit value GW is calculated (and in a configuration in accordance with FIG. 2 is transferred by the computer CP to the memory facility SE).

If a limit value GW already exists, the calibration step CALIB can be left out and a test step TEST is performed in order to test the state of the brake. For this purpose an activation step of the brake LOCK is carried out, provided the brake is not yet applied. Subsequently the measurement and calculation MSRE, CALC of the second distance a2 by the sensor module SB is performed, as already explained above. Then the current brake stop value BAWn (in the case of a configuration in accordance with FIG. 2 by the computer CP) is passed to the memory facility SE. Subsequently the computer CP checks whether the current brake stop value BAWn is still below the limit value GW. For this purpose, the limit value GW is read out from the memory facility SE. For the case in which the limit value GW is reached or exceeded, in an output step OUTPUT, there is the output of a maintenance signal, which can be sent directly to the output facility AE in accordance with FIG. 2 or can be held as a maintenance signal MAINT in the memory facility SE in order to be displayed later.

If the limit value GW is not reached by the brake stop value BAWn, there is a further interrogation, for which the previously established brake stop value BAWn−1 and also the maximum permitted difference ΔMAX for a change of the brake stop value BAW are read out from the memory facility SE. If the calculated difference between the brake stop values BAWn and BAWn−1 is less than the maximum permitted difference ΔMAX, the check is ended and the method is stopped. If the maximum ΔMAX is exceeded, this means that the brake has lost at least one brake block, so that likewise in the output step OUTPUT for the maintenance signal there is an output by the output facility AE or the need for maintenance MAINT is transferred by the computer CP to the memory facility SE for later output. The method is also stopped after this.

Another function that can be fulfilled by means of the inventive sensor arrangement is shown in FIG. 5. This involves the recognition of the brake state, i.e. whether the brake linings are in the activated (applied) setting or the deactivated (released) setting. After the start of the method, the measurement and calculation step MSRE, CALC is performed by the sensor module SB. Here the value W is calculated, which is available for the further method. In a subsequent interrogation, a check is made as to whether the value W roughly corresponds to the current brake stop value BAWn. If this is the case there is an output step OUT LCK indicting that the brake is activated, i.e. in the braked position. Optionally, the value W can be transferred as a new brake stop value BAWn+1 from the computer CP to the memory facility SE. Subsequently, the method is stopped.

If the value W does not roughly correspond to the brake stop value BAWn, then a check is made in a further interrogation step as to whether the value W roughly corresponds to the current release reference value LAWn. If this is the case, output step OUT UNL is performed that indicates the brake is deactivated, i.e. opened. Optionally, the value W can be transferred as the current release reference value LAWn+1 by the computer CP to the memory facility SE. Thereafter the method is stopped.

If the result of the second interrogation step is also negative, i.e. no similarity exists between the value W and the current release reference value LAWn, there is the output step OUTPUT for a maintenance signal. Moreover, a need for maintenance MAINT is transferred by the computer CP to the memory facility SEn. Thereafter the method is stopped.

For the question of whether the value W roughly corresponds to the brake stop value BAWn or the release reference value LAWn, on the one hand measures are to be taken into consideration that can readily be determined with a knowledge of the accuracy of the measuring method (therefore is an approximate match, i.e. with a tolerance interval required). Moreover, it is to be taken into consideration that, as already explained for FIG. 3, a wear-related difference ΔBAW between the brake stop values established can be produced between the measurements. The same also might possibly apply for the release reference value LAW. This change, referred to as drift, in the drift ranges for the brake stop DBB and for the reference position DBL (cf. FIG. 3) is likewise to be taken into account, when the tolerance interval is defined for an approximate match of the value W.

The following is a summary list of reference numerals and the corresponding structure used in the above description of the invention:
a1 First distance
a2 Second distance
a3 Third distance
ABS Distance sensor
BKP Brake blocks
BRB Brake linings
BV Brake apparatus
DG Bogie
Fb Braking force
Fn Normal force
FR Direction of travel
GHS Housing
KKP Ball heads
LAG Length compensation
LST Support bars
RFP Reflection plate
SST Push rods
TE1 First subunit
TE2 Second subunit
WG Side plates
ZR Intermediate space
FZ Vehicle
DG Bogie
RD Wheel
AKT Actuator
BRB Brake lining
AE Output facility
CP Computer
SE Memory facility
SB Sensor module
S1 . . . S3 Interface
CALIB Calibration step
UNLOCK Deactivation step for brake
ANGL Measurement step for angle setting
REFC Measurement step for reference value
CALC Calculation step for setting angle
LOCK Activation step for brake
SET GW Determination step for limit value
TEST Test step
OUTPUT Output of maintenance signal
MAINT Need for maintenance
OUT LCK Output step for activated brake
OUT UNL Output step for deactivated brake
n Measurement
CL Calibration value for the reference position
CB Calibration value for the brake stop
DBB Brake stop drift range
DBL Reference position drift range
BAW Brake stop value
LAW Release reference value
ΔBAW Difference between two brake stop values
ΔMAX Maximum permitted difference
GW Limit value
KV1 Block loss (one brake lining)
KV2 Block loss (two brake linings)
W Value

1. A brake apparatus for installation in an intermediate space between wheels of a twin axle of a track-guided vehicle, the brake apparatus comprising:
two subunits able to be moved relative to one another, and including a first subunit with brake linings for the wheels of a first axle of the twin axle and a second subunit with brake linings for the wheels of a second axle of the twin axle, said subunits, in an installed state, being supported in a displaceable manner in such a way that through a displacement of said subunits contact is made between said brake linings and the wheels; and
at least one distance sensor is disposed in one of said subunits of the brake apparatus, said at least one distance sensor is configured to measure a distance between said first subunit and said second subunit.

2. The brake apparatus according to claim 1, wherein the brake apparatus is configured as a self-supporting structural unit and has mechanical supports for fastening the brake apparatus to the track-guided vehicle.

3. The brake apparatus according to claim 2, wherein said mechanical supports include a suspension unit, which allows a generally horizontal movement of the brake apparatus relative to the track-guided vehicle in the installed state.

4. A track-guided vehicle, comprising:
a twin axle having a first axle with wheels and a second axle with wheels;
a brake apparatus built into an intermediate space of said twin axle, wherein said brake apparatus, containing:
two subunits being moved relative to one another, and including a first subunit with brake linings for said wheels of said first axle of said twin axle and a second subunit with brake linings for said wheels of said second axle of said twin axle, said subunits being disposed in said intermediate space and are supported in a displaceable manner in said intermediate space in such a way that, through a displacement of said subunits, contact is made between said brake linings and said wheels; and
a distance sensor for establishing a brake setting and disposed in the guided track vehicle, said distance sensor is disposed in one of said subunits of said brake apparatus, said distance sensor being configured to measure a distance between said first subunit and said second subunit.

5. A distance sensor, comprising:
a measurement apparatus; and
an attachment apparatus configured to be connected to a subunit of a brake apparatus.

6. The distance sensor according to claim 5, wherein said measurement apparatus is configured to send out a signal and to detect a reflected portion of the signal, wherein a distance is calculated from a time difference between a sending and a receipt of the signal.

7. A method for operation of a brake apparatus or of a track-guided vehicle with the brake apparatus according to claim 4, which comprises the step of:
measuring the distance between the first subunit and the second subunit of the brake apparatus with the distance sensor.

8. The method according to claim 7, which further comprises comparing the distance measured, with computer assistance, with a required distance.

9. The method according to claim 8, wherein:
a brake stop value is predetermined as the required distance, the brake stop value is measured for a stop by a friction force between friction partners of the brake apparatus; and/or
a release reference value is predetermined as the required distance, the release reference value is measured for a stop in a brake mechanism or a predetermined setting of the brake mechanism in a released state of the brake apparatus.

10. The method according to claim 9, wherein the brake stop value is stored as a calibration value for a brake stop and/or the release reference value is a calibration value for a reference position in the released state of the brake apparatus.

11. The method according to claim 9, wherein the brake stop value and/or the distance measured is compared with computer assistance with a limit value for the required distance and there is an output as to whether the brake stop value falls below the limit value and/or reaches the limit value and/or exceeds the limit value.

12. The method according to claim 9, which further comprises:
creating a series of measurements of brake stop values and/or a series of measurements of release reference values with computer assistance; and
comparing a current brake stop value and/or the release reference value with at least one earlier brake stop value and/or the release reference value of the series of measurements.

13. The method according to claim 12, which further comprises calculating a difference between the current brake stop value and the at least one earlier brake stop value of the series of measurements and there is an output as to whether the difference falls below a maximum permitted difference and/or reaches the maximum permitted difference and/or exceeds the maximum permitted difference.

14. The method according to claim 7, which further comprises carrying out the measurement of the distance while the track-guided vehicle is at a standstill.

15. A non-transitory computer medium carrying computer executable instructions that, when the computer executable instructions are executed by a computer, causes said computer to carry out a method for operating a brake apparatus or of a track-guided vehicle with the brake apparatus, which comprises the step of:
measuring a distance between a first subunit and a second subunit of the brake apparatus with a distance sensor.
